(19) United States
(12) Patent Application Publication
(10) Pub. No.: US 2024/0280447 A1
(43) Pub. Date: Aug. 22, 2024

(54) CASSETTE AND TISSUE EMBEDDING METHOD USING SAME

(71) Applicant: LEICA BIOSYSTEMS NUSSLOCH GMBH, Nussloch (DE)

(72) Inventors: Augustine LI, Shanghai (CN); Frank WU, Shanghai (CN); Jay CHEN, Shanghai (CN); Edison YU, Shanghai (CN); Albert CHEN, Shanghai (CN); Chris JIN, Shanghai (CN)

(21) Appl. No.: 18/570,154

(22) PCT Filed: Jun. 18, 2021
(86) PCT No.: PCT/CN2021/100984

§ 371 Date: Dec. 14, 2023

(51) Int. Cl. G01N 1/36; B01L 3/00

(52) U.S. Cl. CPC G01N 1/36; B01L 3/50851; B01L 3/50853; B01L 2200/025; B01L 2200/04; B01L 2300/041; B01L 2300/0609; G01N 2001/366

(57) ABSTRACT

The present disclosure relates to a cassette and a tissue embedding method using the cassette. The cassette includes a frame, a cover and a base. The frame defines an accommodating cavity through a first face and a second face of the frame arranged oppositely in a first direction. The cover is detachably mounted to the frame. The base is detachably mounted to the frame, and the base and the cover are configured to hold and orient a tissue sample therebetween. The base is slidable relative to the frame in a second direction different from the first direction to open and close the accommodating cavity.

### FIELD

The present disclosure relates to a field of tissue processing and embedding, and more particularly to a cassette and a tissue embedding method using the same.

### BACKGROUND

A biopsy is the removal of a tissue sample to examine tissue for signs of cancer or other disorders.

In order to properly process the tissue sample a series of steps may be performed including:

1. Grossing of the sample by cutting the sample to the proper size for analysis.

2. Processing of the sample to immobilize molecular components and/or prevent degradation, generally including fixation, dehydration, clearing and wax infiltration of the tissue sample.

3. Embedding the sample in an embedding material, such as paraffin wax.

4. Sectioning the embedded sample by using, for example, a microtome.

Currently, after the processing of the tissue sample, a user will manually open cassette and transfer tissue to an embedding mold, manually orientate and embed the tissue sample, and this reduces working efficiency.

CN104048864A proposes an apparatus for holding a tissue sample, which allows for the tissue sample to be oriented during the grossing step and to remain in the same orientation through all steps to the embedding step. The apparatus includes a retaining member and a base which cooperate to retain the tissue sample. The retaining member is retractable relative to the base to separate from the base.

The cassette base supports the tissue sample, and will be embedded in the paraffin block together with the tissue sample. Thus, the cassette base will also be cut by a blade during a subsequent sectioning process. This will reduce the lifetime of the blade, and decrease the section quality due to micro defects on the blade edge caused by the base.

### SUMMARY

Embodiments of the present disclosure seek to solve at least one of the problems existing in the related art to at least some extent.

Embodiments of the present disclosure provide a cassette. The cassette includes a frame, a cover and a base. The frame has a first face and a second face arranged oppositely in a first direction and defines an accommodating cavity through the first face and the second face. The cover is detachably mounted to the frame and received in the accommodating cavity. The base is detachably mounted to the frame and received in the accommodating cavity, and the base and the cover are configured to hold and orient a tissue sample therebetween. The base is slidable relative to the frame in a second direction different from the first direction to open and close the accommodating cavity.

In the cassette according to embodiments of the present disclosure, the cover is detachably mounted to the frame, and the base is detachably mounted to the frame. Thus, the tissue sample can be held and oriented between the cover and the base. Furthermore, the frame defines the accommodating cavity through the first face and the second face of the frame arranged oppositely in the first direction, and the base is slidable relative to the frame in a second direction different from the first direction. Thus, the base can selectively open and close the accommodating cavity. When the base is opened, the tissue sample can be removed from the cassette easily to facilitate automation of the tissue embedding process.

In some embodiments, the second direction is perpendicular to the first direction. Thus, the base can be laterally slid into or out from the frame.

In some embodiments, the frame defines a guide groove extending in the second direction, the base defines a guide portion, and the guide portion is slidably fitted in the guide groove. Thus, the base can be slid into or out from the frame through fit between the guide groove and the guide portion.

In some embodiments, the base is provided with a limit portion, the frame defines a limit groove, and the limit portion is fitted in the limit groove to limit an extreme position where the base is slidable into the frame. Thus, the base can be located at an appropriate position to close the accommodating cavity.

In some embodiments, the base is provided with a rib for coupling the guide portion and the limit portion. Thus, the strength of the base is enhanced.

In some embodiments, the base is provided with an operation portion, and the base is slidable through the operation portion. By handling the operation portion, the base can be easily slid into or out from the frame.

In some embodiments, the base is provided with a plurality of through holes extending in the first direction. Thus, the base allows passage of reagent for tissue processing.

In some embodiments, the cover is displaceable relative to the frame in the first direction. Thus, the depth of the cover in the accommodating cavity can be varied to adapt the tissue sample of different thicknesses.

In some embodiments, the cover is provided with a lug, the frame defines a receiving groove, and the lug is fitted in the receiving groove. Thus, the cover can be mounted to the frame through fit between the lug and the receiving groove.

In some embodiments, the cover is provided a plurality of teeth on a side face of the receiving groove, the lug has a tooth shape, and the lug is engageable with the plurality of teeth to define different engagement positions of cover relative to the frame. Thus, the cover can be held in the accommodating cavity by engagement of the tooth-shaped lug and the plurality of teeth in the receiving groove. Moreover, the tooth-shaped lug can selectively engage with the plurality of teeth in the receiving groove, to define different engagement positions between the cover and the frame. That is, the depth of the cover in the accommodating cavity can be varied.

In some embodiments, the cover defines a plurality of through holes extending in the first direction. Thus, the cover allows passage of reagent for tissue processing.

In some embodiments, the frame is provided with a first stage extending from an inner wall face of the frame towards the accommodating cavity, and the first stage abuts against the base. Thus, the first stage can assist in guiding and holding the base in the frame.

Embodiments of the present disclosure further provide a tissue embedding method using a cassette according to any one of the above embodiments. The tissue embedding method includes placing the cassette having the tissue sample on a mold; siding the base of the cassette out of the frame of the cassette to open the accommodating cavity; pushing the tissue sample into the mold by means of a pusher; sliding the base of the cassette into the frame of the cassette, to close the accommodating cavity; dispensing liquid paraffin into the cassette and the mold; removing the pusher; and cooling the liquid paraffin into a solid block.

The tissue embedding method according to embodiments of the present disclosure employs the cassette according to any one of the above embodiments. The base is slidably mounted to the frame of the cassette to open or close the accommodating cavity. Thus, the tissue sample can be easily removed from the cassette to facilitate automation of the tissue embedding process.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a perspective view of a cassette according to an embodiment of the present disclosure.

FIG. 2 is another perspective view of a cassette according to an embodiment of the present disclosure.

FIG. 3 is an exploded view of a cassette according to an embodiment of the present disclosure.

FIG. 4 is a sectional view of a cassette according to an embodiment of the present disclosure.

FIG. 5 is a perspective view of a frame of a cassette according to an embodiment of the present disclosure.

FIG. 6 is another perspective view of a frame of a cassette according to an embodiment of the present disclosure.

FIG. 7 is a perspective view of a base of a cassette according to an embodiment of the present disclosure.

FIG. 8 is another perspective view of a base of a cassette according to an embodiment of the present disclosure.

FIG. 9 is a perspective view of a cover of a cassette according to an embodiment of the present disclosure.

FIG. 10 is another perspective view of a cover of a cassette according to an embodiment of the present disclosure.

FIG. 11 is a first schematic cross-sectional view of a cassette used in a tissue embedding process according to the present disclosure.

FIG. 12 is a second schematic cross-sectional view of a cassette used in a tissue embedding process according to the present disclosure.

FIG. 13 is a third schematic cross-sectional view of a cassette used in a tissue embedding process according to the present disclosure.

FIG. 14 is a fourth schematic cross-sectional view of a cassette used in a tissue embedding process according to the present disclosure.

FIG. 15 is a fifth schematic cross-sectional view of a cassette used in a tissue embedding process according to the present disclosure.

FIG. 16 is a sixth schematic cross-sectional view of a cassette used in a tissue embedding process according to the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

In the specification, unless specified or limited otherwise, relative terms such as “central”, “longitudinal”, “lateral”, “front”, “rear”, “right”, “left”, “inner”, “outer”, “lower”, “upper”, “horizontal”, “vertical”, “above”, “below”, “up”, “top”, “bottom” as well as derivative thereof (e.g., “horizontally”, “downwardly”, “upwardly”, etc.) should be construed to refer to the orientation as then described or as shown in the drawings under discussion. These relative terms are for convenience of description and do not require that the present disclosure be constructed or operated in a particular orientation.

Terms concerning attachments, coupling and the like, such as “connected” and “interconnected”, refer to a relationship in which structures are secured or attached to one another either directly or indirectly through intervening structures, as well as both movable or rigid attachments or relationships, unless expressly described otherwise.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

In the description of the present disclosure, it should be understood that, unless specified or limited otherwise, the terms “mounted,” “connected,” and “coupled” and variations thereof are used broadly and encompass such as mechanical or electrical mountings, connections and couplings, also can be inner mountings, connections and couplings of two components, and further can be direct and indirect mountings, connections, and couplings, which can be understood by those skilled in the art according to the detail embodiment of the present disclosure.

According to embodiments of the present disclosure, a cassette 1000 is provided. The cassette 1000 includes a frame 100, a cover 300 and a base 200. The frame 100 has a first face and a second face arranged oppositely in a first direction, and defines an accommodating cavity 109 through the first face and the second face. The cover 300 is detachably mounted to the frame 100 and received in the accommodating cavity 109. The base 200 is detachably mounted to the frame 100 and received in the accommodating cavity 109, and the base 200 and the cover 300 are configured to hold and orient a tissue sample therebetween. The base 200 is slidable relative to the frame 100 in a second direction different from the first direction to open and close the accommodating cavity 109.

In the cassette 1000 according to embodiments of the present disclosure, the cover 300 is detachably mounted to the frame 100, and the base 200 is detachably mounted to the frame 100. Thus, the tissue sample can be held and oriented between the cover 300 and the base 200. Furthermore, the frame 100 defines the accommodating cavity 109 through the first face and the second face of the frame 100 arranged oppositely in the first direction, and the base 200 is slidable relative to the frame 100 in a second direction different from the first direction. Thus, the base 200 can selectively open and close the accommodating cavity 109. When the base 200 is opened, the tissue sample can be removed from the cassette 1000 easily to facilitate automation of the tissue embedding process.

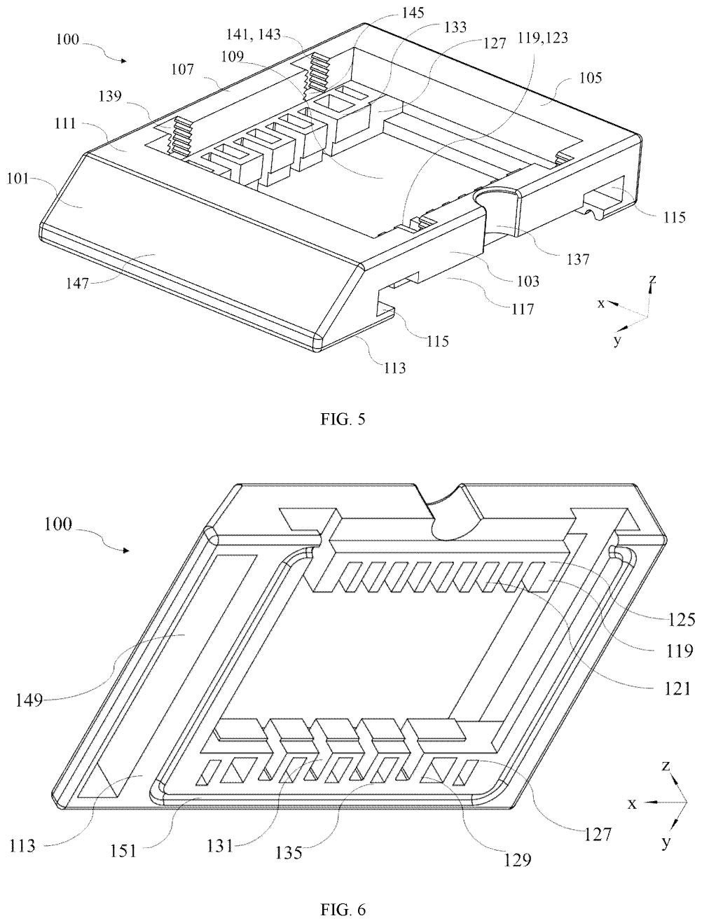

It could be understood that, the frame 100 defines the accommodating cavity 109 through the first face and the second face of the frame 100 arranged oppositely in the first direction. That is, the frame 100 is opened in opposite first and second face in the first direction. For example, as illustrated in FIGS. 5 and 6, the first face is a top face 111 of the frame 100, the second face is bottom face 113 of the frame 100, and the first direction is a thickness direction of the frame 100 (a direction along Z-axis).

The accommodating cavity 109 passes through the top face 111 and the bottom face 113 of the frame 100. The cover 300 is detachably mounted to the frame 100 and can be received in the accommodating cavity 109 from the opened top face 111 of the frame 100. The base 200 is detachably mounted to the frame 100 and slidable relative to the frame 100 along a direction different from the thickness direction of the frame 100. The base 200 can be slid into the frame 100 to close the accommodating cavity 109, and spaced apart from the cover 300 in the thickness direction to hold and orient the tissue sample therebetween. The base 200 can be slid out from the frame 100 to open the accommodating cavity 109, and thus the tissue sample can be easily removed from the accommodating cavity 109 through the opened bottom face 113 of the frame 100.

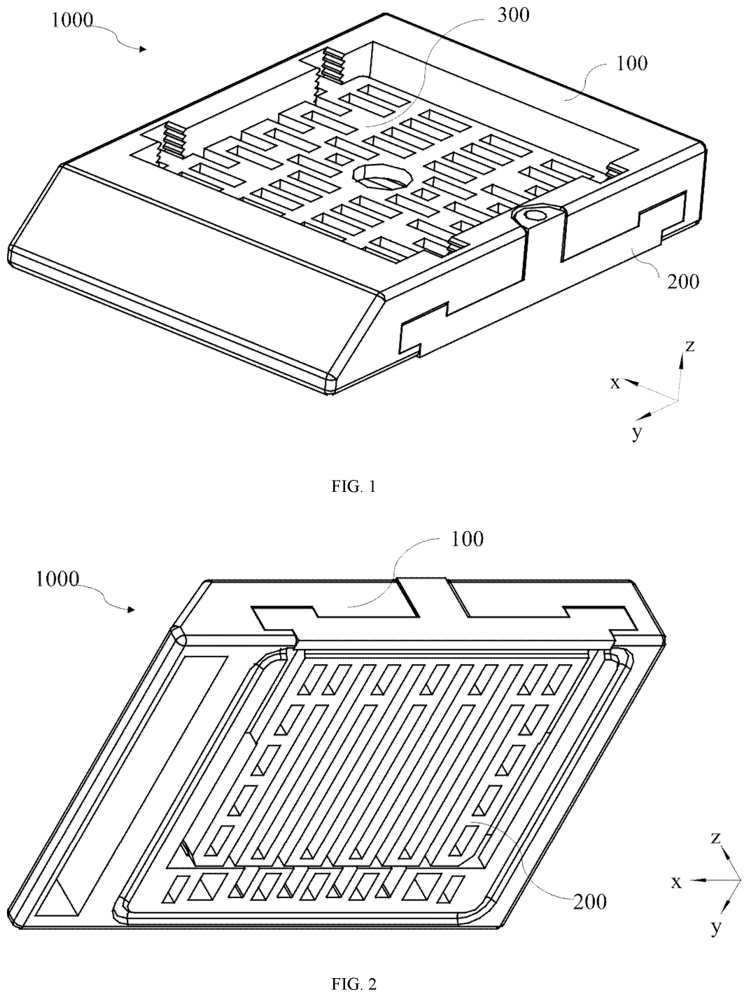

As illustrated in FIG. 1, a cross section of the accommodating cavity 109 is rectangular. However, the cross section of the accommodating cavity 109 may be in other shapes. For example, the cross section of the accommodating cavity 109 may be circular, square and so on, which is not specifically limited.

In some embodiments, the second direction is perpendicular to the first direction. Thus, the base 200 can be laterally slid into or out from the frame 100.

It could be understood that, the second direction may be a length direction (a direction along Y-axis) or a width direction (a direction along X-axis) of the frame 100.

It should be noted that, in other embodiments, the second direction may also not perpendicular to the first direction, which is not specifically limited.

In some embodiments, the frame 100 defines a guide groove 115 extending in the second direction, the base 200 defines a guide portion 221, and the guide portion 221 is slidably fitted in the guide groove 115. Thus, the base 200 can be slid into or out from the frame 100 through fit between the guide groove 115 and the guide portion 221.

It could be understood that, also, the guide groove 115 may be defined in the base 200, and the guide portion 221 is provided on the frame 100, which is not specifically limited herein.

In some embodiments, the base 200 is provided with a limit portion 219, the frame 100 defines a limit groove 137, and the limit portion 219 is fitted in the limit groove 137 to limit an extreme position where the base 200 is slidable into the frame 100. Thus, the base 200 can be located at an appropriate position to close the accommodating cavity 109.

In some embodiments, the base 200 is provided with a rib 233 for coupling the guide portion 221 and the limit portion 219. Thus, the strength of the base 200 is enhanced.

In some embodiments, the base 200 is provided with an operation portion, and the base 200 is slidable through the operation portion. By handling the operation portion, the base 200 can be easily slid into or out from the frame 100.

For example, the operation portion may be a recessed hole 235 defined in the limit portion 219 of the base 200. Thus, a tool, particularly a tool of an automatic tissue embedding machine, fitted with the recessed hole 235 can be easily used to assist in sliding the base 200, facilitating automation of tissue embedding process.

In some embodiments, the base 200 is provided with a plurality of through holes extending in the first direction. Thus, the base 200 allows passage of reagent for tissue processing.

In some embodiments, the cover 300 is displaceable relative to the frame 100 in the first direction. Thus, the depth of the cover 300 in the accommodating cavity 109 can be varied to adapt the tissue sample of different thicknesses.

In some embodiments, the cover 300 is provided with a lug 317, the frame 100 defines a receiving groove 139, and the lug 317 is fitted in the receiving groove 139. Thus, the cover 300 can be mounted to the frame 100 through fit between the lug 317 and the receiving groove 139.

In some embodiments, the cover 300 is provided a plurality of teeth on a side face of the receiving groove 139, the lug 317 has a tooth shape, and the lug 317 is engageable with the plurality of teeth to define different engagement positions of cover 300 relative to the frame 100. Thus, the cover 300 can be held in the accommodating cavity 109 by engagement of the tooth-shaped lug 317 and the plurality of teeth in the receiving groove 139. Moreover, the tooth-shaped lug 317 can selectively engage with the plurality of teeth in the receiving groove 139, to define different engagement positions between the cover 300 and the frame 100. That is, the depth of the cover 300 in the accommodating cavity 109 can be varied.

In some embodiments, the cover 300 defines a plurality of through holes extending in the first direction. Thus, the cover 300 allows passage of reagent for tissue processing.

In some embodiments, the frame 100 is provided with a first stage 119 extending from an inner wall face of the frame 100 towards the accommodating cavity 109, and the first stage 119 abuts against the base 200. Thus, the first stage 119 can assist in guiding and holding the base 200 in the frame 100.

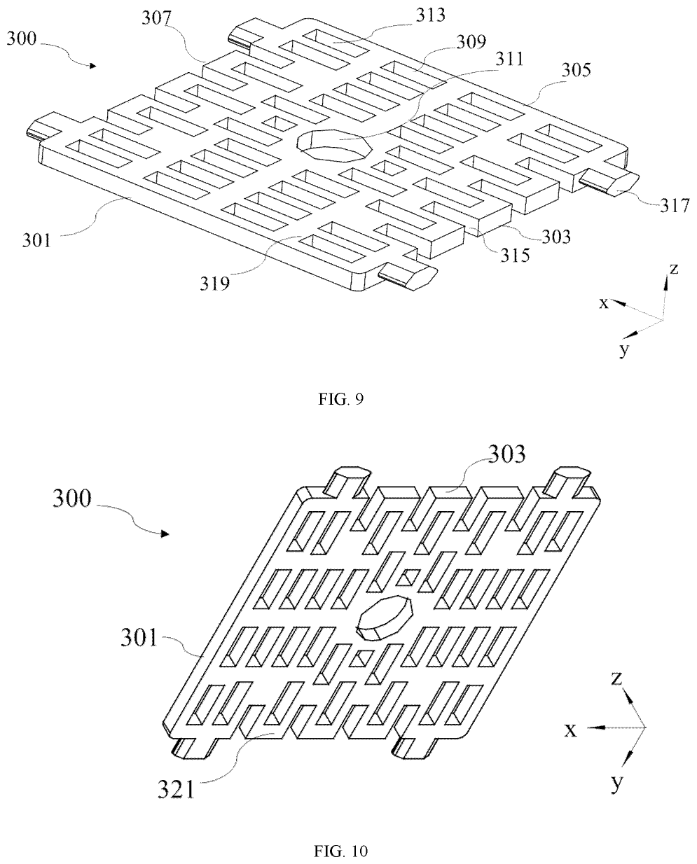

According to an embodiment of the present disclosure, a cassette 1000 will be described in detail below with reference to FIGS. 1 to 10. The orthogonal XYZ-axis is illustrated in order to facilitate the description and determine the directions. In which, the positive direction of the X-axis is the left direction and the negative direction of the X-axis is the right direction; the positive direction of the Y-axis is the front direction and the negative direction of the Y-axis is the rear direction; the positive direction of the Z-axis is the up direction and the negative direction of the Z-axis down direction.

As illustrated in FIGS. 1 to 4, the cassette 1000 includes a frame 100, a base 200 and a cover 300.

As illustrated in FIGS. 5 and 6, the frame 100 has a substantially rectangular prism shape. The frame 100 includes a first wall 101, a second wall 103, a third wall 105 and a fourth wall 107. The first through fourth walls 101, 102, 103 and 104 are sequentially coupled end to end, to defines an accommodating cavity 109 through a top face 111 and a bottom face 113 of the frame 100 along a thickness direction of the frame 100. That is, the accommodating cavity 109 has a substantially rectangular shape, and defines a top opening and a bottom opening. The first and third walls 101, 105 are arranged oppositely in a length direction of the frame 100, and the second and fourth walls 103, 107 are arranged oppositely in a width direction of the frame 100.

The first and third walls 101, 105 each define a guide groove 115 extending along the width direction, opening towards the accommodating cavity 109 and an outer face of the second wall 103.

The frame 100 defines an opening 117 through the second wall 103 in the width direction, and the opening 117 is in communication with the two guide grooves 115.

The frame 100 is provided a first stage 119 extending inwards from the second wall 103. The first stage 119 defines nine slots 121 through the first stage 119 in the thickness direction. The nine slots 121 are substantially evenly spaced in the length direction. The first stage 119 is spaced apart from the first and third walls 101, 105 in the length direction. The first stage 119 has a top face 123 below the top face 111 of the frame 100, and a bottom face 125 above the bottom face 113 of the frame 100.

The frame 100 is provided with a second stage 127 extending from the fourth wall 107 towards the accommodating cavity 109. The second stage 127 defines seven rectangular holes 129 and four rectangular slots 131 that pass through the second stage 127. The seven rectangular holes 129 and four rectangular slots 131 are substantially evenly spaced in the length direction, and arranged alternately in the length direction. The second stage 127 is coupled to the first and third walls 101, 105 in the length direction, and has a top face 133 below the top face 111 of the frame 100 and a bottom face 135 flush with the bottom face 113 of the frame 100.

The top face 123 of the first stage 119 is flush with the top face 133 of the second stage 127.

The frame 100 defines a semi-cylindrical limit groove 137 recessed from the outer face of the second wall 103.

The frame 100 defines two receiving grooves 139 recessed from an inner face of the second wall 103, and two receiving grooves 139 recessed from an inner face of the fourth wall 107. The two receiving grooves 139 in the second wall 103 are spaced in the length direction, and the two receiving grooves 139 in the fourth wall 107 are spaced in the length direction. Moreover, the two receiving grooves 139 in the second wall 103 are arranged opposite the two receiving grooves 139 in the fourth wall 107 respectively.

For each receiving groove 139, two side faces 141 that opposite each other in the length direction are each provided with a plurality of teeth 143.

Each of the four receiving grooves 139 has a bottom face 145 flush with the top face 123 of the first stage 119 or the second stage 127, and is opened towards the top face 111 of the frame 100.

The frame 100 has an inclined face 147 at the first wall 101. The frame 100 defines a recess 149 in the bottom face 113 at the first wall 101, and the recess 149 extends in the width direction. Furthermore, the frame 100 defines an annular groove 151 in the bottom face 113 at the first wall 101, the third wall 105 and the fourth wall 107, and the annular groove 151 is in communication with the opening 117 in the second wall 103.

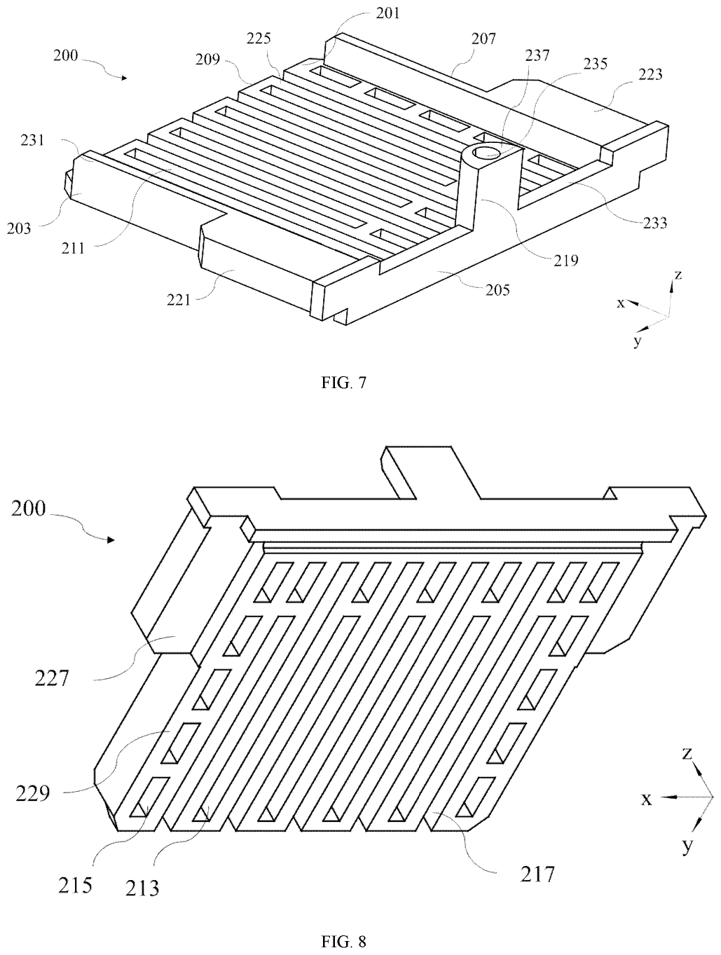

As illustrated in FIGS. 7 and 8, the base 200 has a plate-shaped base body 201. The base body 201 has a first edge 203, a second edge 205, a third edge 207 and the fourth edge 209 that are sequentially coupled end to end. The first and third edges 203, 207 are arranged oppositely in the length direction, and the second and fourth edges 205, 209 are arranged oppositely in the width direction. The base 200 defines a plurality of holes 211 through the base body 201 in the thickness direction. The plurality of holes 211 comprise four elongated rectangular holes 213, fifteen short rectangular holes 215 and five elongated rectangular slots 217. Ten of the short rectangular holes 215 are distributed at first and third edges 203, 207 of the base body 201 in the length direction, and the remaining five short rectangular holes 215 and the five elongated rectangular slots 217 constitute five groups of holes respectively. The five groups of holes and the five elongated rectangular holes 213 are arranged alternately in the length direction.

The base 200 is provided with a semi-cylindrical limit portion 219 extending upwards from the second edge 205 of the base body 201. The limit portion 219 is located at a center of the second edge 205 of the base body 201, and its semi-cylindrical face faces inwards.

The base 200 is provided with two guide portions 221, and the two guide portions 221 extend outwards from first and third edges 203, 207 of the base body 201 arranged oppositely in the length direction, respectively. The guide portion 221 has a top face 223 above a top face 225 of the base body 201, and a bottom face 227 above a bottom face 229 of the base body 201.

The base 200 is further provided with two flanges 231, and the two flanges 231 extend upwards from the first and third edges 203, 207 of the base body 201 arranged oppositely in the length direction, respectively. The two flanges 231 are connected between respective guide portions 221 and respective edges to enhance reliability of the connection between the guide portions 221 and the edges. The flanges 231 extend substantially along the whole of the respective edges, and the guide portions 221 extend along a part of the respective edges, to define notches between the guide portions 221 and the flanges 231.

The base 200 is further provided with a rib 233 extending upwards from the second edge 205, the rib 233 is coupled the two guide portions 221 to the limit portion 219, to enhance the strength of the base 200.

The base 200 defines a recessed hole 235 in the limit portion 219, and the recessed hole 235 is recessed from a top face 237 of the limit portion 219.

As illustrated in FIGS. 7 and 8, the cover 300 has a substantially rectangular plate shape. The cover 300 has a cover body 301. The cover body 301 has a first edge 302 and a third edge 305 opposite each other in the length direction, and a second edge 303 and a fourth edge 307 opposite each other in the width direction. The first through fourth edges 302, 303, 305 and 307 are coupled end to end.

The cover body 301 defines a plurality of holes 309. The plurality of holes 309 includes a circular hole 311 in a center of the cover body 301, thirty-six rectangular holes 313, and eight rectangular slots 315. The rectangular holes 313 are distributed in four columns in the length direction. The column close to the second edge 303 has seven rectangular holes 313, the column close to the fourth edge 307 has seven rectangular holes 313, and the remaining two columns has eleven rectangular holes 313 respectively. Four of the rectangular slots 315 are defined at the second edge 303 of the cover body 301, and the remaining rectangular slots 315 are defined at the fourth edge 307 of the cover body 301. The four rectangular slots 315 at the second edge 303 and the rectangular holes 33 at the second edge 303 are alternately arranged, and the four rectangular slots 315 at the fourth edge 307 and the rectangular holes 313 at the fourth edge 307 are alternately arranged.

The cover 300 is further provided with two lugs 317 extending outwards from the second edge 303 of the cover body 301 in the width direction, and two lugs 317 extending outwards from the fourth edge 307 of the cover body 301 in the width direction. The two lugs 317 at the second edge 303 are evenly distributed in the length direction, and the two lugs 317 at the fourth edge 307 are evenly distributed in the length direction. The two lugs 317 at the second edge 303 are arranged opposite the two lugs 317 at the fourth edge 307, respectively.

Each lug 317 forms teeth at two opposite edges in the length direction.

As illustrated in FIGS. 1 to 4, the two guide portions 221 of the base 200 can be fitted into the guide grooves 115 in the frame 100, and thus the base 200 can be slidably fitted in the frame 100. That is, the base 200 is slidable relative to the frame 100, and the base 200 can be mounted to or removed from the frame 100, to form a drawer-type base 200. The limit portion 219 defines the recessed hole 235, and a tool, particularly a tool of an automatic tissue embedding machine, fitted with the recessed hole 235 can be easily used to assist in sliding the base 200, facilitating automation of tissue embedding process.

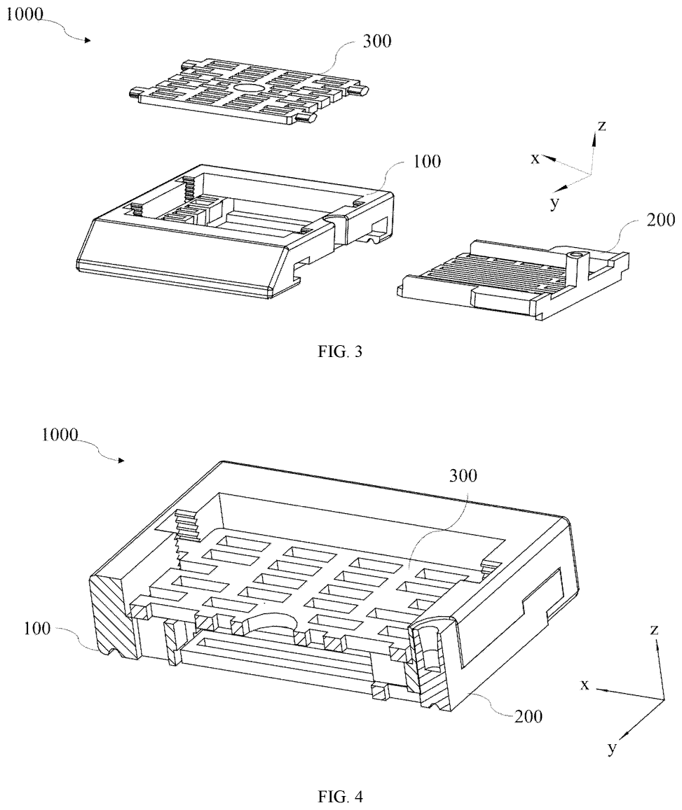

As illustrated in FIG. 4, when the base 200 is mounted to the frame 100, the limit portion 219 of the base 200 is fitted in the limit groove 137 of the frame 100. The side face of the base 200 at the second edge 303 is flush with the outer face of the frame 100 at the second wall 103, and the bottom face of the base 200 is flush with the bottom face 113 of the frame 100. The bottom face 125 of the first stage 119 abuts against the top face 225 of the base body 201, and the bottom face 227 of the guide portion 221 of the base 200 abuts against the bottom face of the guide groove 115 of the frame 100, to stably hold the base 200 in the frame 100. Moreover, the fourth edge 209 of the base 200 is close to the second stage 127 of the frame 100, to substantially close the accommodating cavity 109.

As illustrated in FIG., the holes and slots in the first stage 119 and the second stage 127 of the frame 100 are aligned with the holes and slots in the base 200 in the width direction.

As illustrated in FIGS. 1 and 4, the four lugs 317 of the cover 300 are fitted in the receiving grooves 139 of the frame 100, respectively, and the tooth-shaped lugs 317 are engaged with the teeth 143 in the receiving grooves 139, to limit a depth of the cover 300 in the accommodating cavity 109 of the frame 100. The tooth-shaped lugs 317 may be engaged with different teeth 143 in the receiving grooves 139 to limit different depths of the cover 300 in the accommodating cavity 109 of the frame 100, to change distance between the bottom face of the cover 300 and the top face of the base 200. Thus, the cassette 1000 can adapt to tissue samples of different thicknesses.

As illustrated in FIGS. 1, 2 and 4, the holes and slots in the first stage 119 and the second stage 127 of the frame 100 are aligned with the holes and slots in the cover 300 in the width direction. Thus, the holes and slots in the base 200 are aligned with the holes and slots in the cover 300 in the width direction. It could be understood that the cassette 1000 according to the embodiment of the present disclosure is particularly advantageous to apply in tissue processing (fixation, dehydration, clearing and wax infiltration).

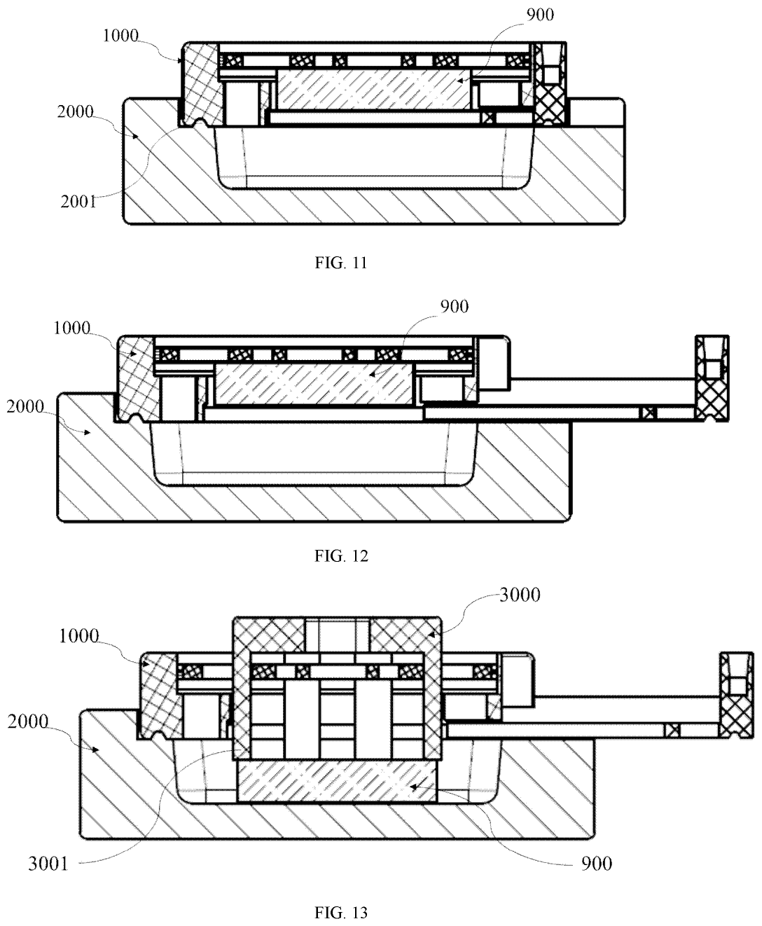

With reference to FIGS. 11 to 16, the cassette 1000 according to above embodiments of the present embodiments may also be applied in the tissue embedding process, to facilitate automation of the tissue embedding process.

Embodiments of the present disclosure also provide a tissue embedding method using a cassette 1000 according to the above embodiment, including the followings steps.

As illustrated in FIG. 11, the cassette 1000 having the tissue sample 900 is placed on a mold 2000.

It could be understood that, the tissue sample 900 is received in the accommodating cavity 109 of the cassette 1000 and held and oriented between the cover 300 and the base 200 of the cassette 1000, to perform the tissue processing. The processed tissue sample 900 is still held and oriented in cassette 1000, to perform a tissue embedding process.

Additionally, it could be understood that, the mold 2000 is provided with an annular protrusion 2001 fitted with the annular groove 151 in the bottom face 229 of the base 200 of the cassette 1000, to stably mount the cassette 1000 to the mold 2000. It could be understood that, the mold 2000 may be a part of an automatic tissue embedding machine, to facilitate automation of the tissue embedding process.

As illustrated in FIG. 12, the base 200 of the cassette 1000 is slid out of the frame 100 of the cassette 1000 to open the accommodating cavity 109.

It could be understood that, the base 200 of the cassette 1000 defines that recessed hole 235, and the base 200 can be slid by a tool fitted with the recessed hole 235. It could be understood that, the tool may be a part of an automatic tissue embedding machine, and its motion may be controlled by the automatic tissue embedding machine, thus the base 200 can be automatically withdrawn from the frame 100, to facilitate automation of the tissue embedding process.

As illustrated in FIG. 13, the tissue sample 900 is pushed into the mold 2000 by means of a pusher 3000.

It could be understood that, the cover 300 and the frame 100 of the cassette 1000 define holes and slots, thus the pusher 3000 may have legs 3001 that can pass through these holes and slots, to push the tissue sample 900 into the mold 2000 and hold it in the mold 2000.

It could be understood that, the pusher 3000 may be a part of an automatic tissue embedding machine, and its motion may be controlled by the automatic tissue embedding machine, thus tissue sample 900 can be automatically pushed into the mold 2000, to facilitate automation of the tissue embedding process.

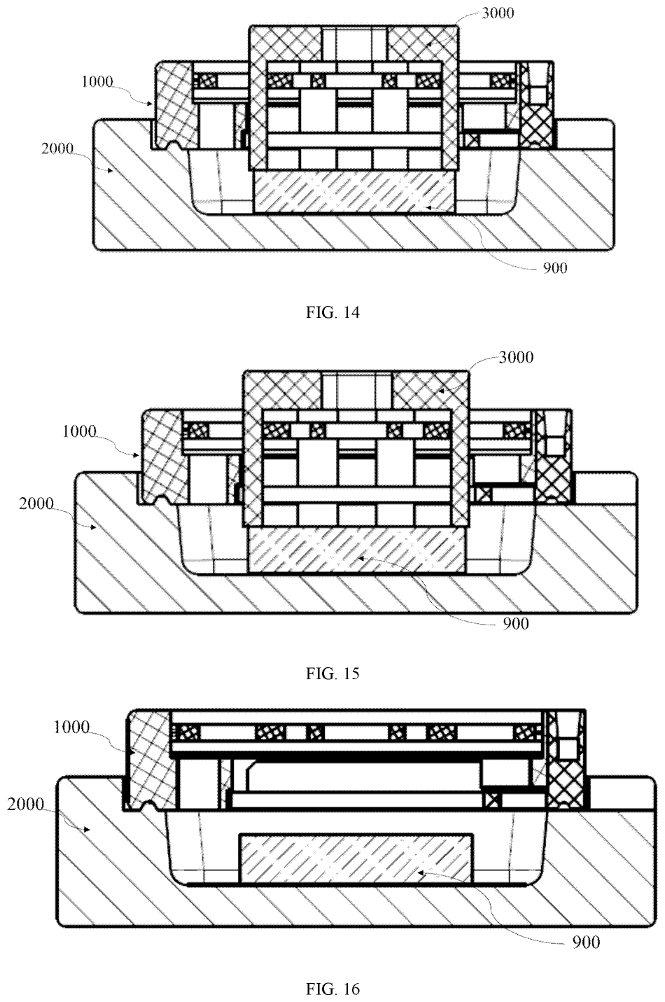

As illustrated in FIG. 14, the base 200 of the cassette 1000 is slid into the frame 100 of the cassette 1000 to close the accommodating cavity 109.

Similarly, the base 200 can be slid by a tool fitted with the recessed hole 235, to bring the base 200 of the cassette 1000 into the frame 100 of the cassette 1000, to close the accommodating cavity 109.

It could be understood that, the elongated rectangular slots 217 in the base 200 of the cassette 1000 correspond to the legs 3001 of the pusher 3000, and the pusher 3000 will not hinder the base 200. Thus, the base 200 can be smoothly slid into the frame 100.

As illustrated in FIG. 15, liquid paraffin is dispensed into the cassette 1000 and the mold 2000.

It could be understood that, the liquid paraffin can be dispensed through the circular hole 311 in the center of the cover 300. Generally, the dispensing will stop until the level of the liquid paraffin is higher than the top face 319 of the cover 300.

It could be understood that, the liquid paraffin can be dispensed by a paraffin dispenser. Moreover, the paraffin dispenser may be a part of an automatic tissue embedding machine, and its motion may be controlled by the automatic tissue embedding machine, thus liquid paraffin can be automatically dispensed, to facilitate automation of the tissue embedding process.

As illustrated in FIG. 16, the pusher 3000 is removed.

Also, the motion of the pusher 3000 may be controlled by the automatic tissue embedding machine, to facilitate automation of the tissue embedding process.

As illustrated in FIG. 16, the liquid paraffin is cooled into a solid block.

In this way, the cassette 1000 and the tissue sample 900 are “frozen” together by the paraffin, and can be removed from the mold 2000 as a whole, to complete the tissue embedding process.

In some embodiments, the tissue embedding method further includes slightly cooling the paraffin to attach the tissue sample 900 to the mold 2000 prior to the step of removing the pusher 3000. Thus, the tissue sample 900 can be prevented from being carried upwards by the pusher 3000 when the pusher 3000 is being removed.

It could be understood that, the tissue sample 900 embedded by the paraffin is located outside the cassette 1000, and can be conveniently separated from the cassette 1000, and the embedded paraffin block can be applied in the subsequent tissue sectioning process.

It should be noted that, although the present disclosure has been described with reference to the embodiments, it will be appreciated by those skilled in the art that the disclosure includes other examples that occur to those skilled in the art to execute the disclosure. Therefore, the present disclosure is not limited to the embodiments.

1. A cassette, comprising:
a frame having a first face and a second face arranged oppositely in a first direction and defining an accommodating cavity through the first face and the second face;
a cover detachably mounted to the frame and received in the accommodating cavity; and
a base detachably mounted to the frame and received in the accommodating cavity, the base and the cover being configured to hold and orient a tissue sample therebetween,
wherein the base is slidable relative to the frame in a second direction different from the first direction to open and close the accommodating cavity.

2. The cassette according to claim 1, wherein the second direction is perpendicular to the first direction.

3. The cassette according to claim 1, wherein the frame defines a guide groove extending in the second direction, the base defines a guide portion, and the guide portion is slidably fitted in the guide groove.

4. The cassette according to claim 3, wherein the base is provided with a limit portion, the frame defines a limit groove, the limit portion is fitted in the limit groove to limit an extreme position where the base is slidable into the frame.

5. The cassette according to claim 4, wherein the base is provided with a rib for coupling the guide portion and the limit portion.

6. The cassette according to claim 1, wherein the base is provided with an operation portion, and the base is slidable through the operation portion.

7. The cassette according to claim 1, wherein the base is provided with a plurality of through holes extending in the first direction.

8. The cassette according to claim 1, wherein the cover is displaceable relative to the frame in the first direction.

9. The cassette according to claim 1, wherein the cover is provided with a lug, the frame defines a receiving groove, and the lug is fitted in the receiving groove.

10. The cassette according to claim 9, wherein the cover is provided a plurality of teeth on a side face of the receiving groove, the lug has a tooth shape, and the lug is engageable with the plurality of teeth to define different engagement positions of cover relative to the frame.

11. The cassette according to claim 1, wherein the cover defines a plurality of through holes extending in the first direction.

12. The cassette according to claim 1, wherein the frame is provided with a first stage extending from an inner wall face of the frame towards the accommodating cavity, and the first stage abuts against the base.

13. A tissue embedding method using a cassette according to claim 1, comprising:
placing the cassette having the tissue sample on a mold;
sliding the base of the cassette out of the frame of the cassette to open the accommodating cavity;
pushing the tissue sample into the mold by means of a pusher;
sliding the base of the cassette into the frame of the cassette, to close the accommodating cavity;
dispensing liquid paraffin into the cassette and the mold;
removing the pusher; and
cooling the liquid paraffin into a solid block.

14. The tissue embedding method according to claim 13, comprising slightly cooling the liquid paraffin to attach the tissue sample to the mold prior to the step of removing the pusher.
